(19) United States
(12) Patent Application Publication
(10) Pub. No.: US 2025/0093231 A1
(43) Pub. Date: Mar. 20, 2025

(54) SYSTEM AND METHOD TO DETECT ANOMALY IN MECHANICAL COMPONENTS

(71) Applicant: PES University, Bengaluru (IN)

(72) Inventors: Ananya Mungara, Bangalore (IN); Tarakesh Mogallapalli, Bangalore (IN); Manjunath G, Bangalore (IN); Namratha V. Reddy, Bangalore (IN); Immanuel Calvin D, Bangalore (IN)

(21) Appl. No.: 18/889,456

(22) Filed: Sep. 19, 2024

(30) Foreign Application Priority Data
Sep. 20, 2023 (IN) 202341063232

(51) Int. Cl. G01M 13/00

(52) U.S. Cl. CPC G01M 13/00

(57) ABSTRACT

A method to detect anomaly in mechanical components based on sound, vibration, and temperature analysis is disclosed. The method includes receiving sound, vibration, and temperature data from the mechanical components in real-time. Further, the method includes generating synthesized sound data from the received sound data based on varying noise environments by performing pitch changing, temporal stretching, and noise injection. Furthermore, the method includes preprocessing the received data and the synthesized sound data to remove background noise and thermal shifting. Moreover, the method includes extracting one or more features from the preprocessed data. Additionally, the method includes identifying anomaly in the mechanical components based on the extracted one or more features by employing one or more Machine Learning (ML) models. The method also includes rendering at least the identified anomaly in the mechanical components to a user.

### CROSS-REFERENCE TO RELATED APPLICATION

This application is based upon and claims priority from, Application No. IN 202341063232, filed on 20 Sep. 2023 the entireties which are incorporated herein by reference for all purposes.

### TECHNICAL FIELD

The present disclosure relates to the field of mechanical components diagnosis, and in particular, relates to a noise, vibration, and temperature analysis system and method for detecting anomaly in mechanical components.

### BACKGROUND

Mechanical components are integral to the operation of various machines across industries, ensuring functionality, safety, and performance. Whether in manufacturing equipment, industrial machinery, or automotive vehicles, these components face constant stress, environmental factors, and wear that can lead to deterioration over time. The prompt identification and precise diagnosis of equipment, machinery, and vehicle defects are crucial in many industries, including automotive, manufacturing, and heavy machinery. These procedures are essential for guaranteeing human safety as well as the continuous operation of vital systems, eliminating expensive malfunctions, and cutting down on production downtime.

Maintenance practices across different sectors have relied on periodic inspections or reactive responses to visible signs of wear or malfunction, often resulting in unexpected downtime and costly repairs. These techniques frequently involve laborious processes and rely heavily on sensor data and manual checks. While successful to some extent, the current landscape of defect diagnosis approaches has several intrinsic drawbacks. These techniques usually uncover problems after they have already appeared, which can result in expensive repairs, decreased operational effectiveness, and, in some situations, serious safety threats.

Moreover, when dealing with subtle or newly appearing defects, the shortcomings of conventional fault identification techniques become very clear. Such problems cannot show symptoms that are obvious in the early stages or during routine inspections, demanding more advanced and proactive diagnostic techniques. The capacity to identify hidden issues before they worsen as machinery and equipment become more complicated and interconnected is essential for maintaining optimal performance, cost-effectiveness, and safety. Environmental factors can also make it difficult for conventional diagnostic techniques to work, especially when there are noisy or difficult operational circumstances. Sensor data may be subject to interference, which could result in unreliable evaluations and false positives or negatives. The accuracy of sensor-based detection may further worsen in scenarios with considerable variations in ambient noise or the surrounding environment.

Thus, there is a need for an improved system and method for detecting anomaly in mechanical components to overcome the above-mentioned drawbacks for precisely and proactively detecting faults, even those in their early stages, while minimizing the impact of external factors like noise to improve the maintenance and safety standards across a variety of industries.

### BRIEF SUMMARY OF THE DISCLOSURE

When mechanical components within a machine develop issues, such as wear, misalignment, or damage, these problems often manifest through changes in the characteristics of sound, vibration, and temperature. Sound, vibration, and temperature analysis are invaluable techniques for detecting such anomalies, providing critical insights into the health and condition of the machinery. Anomalies can lead to alterations in frequency and amplitude, as well as the emergence of abnormal patterns, such as sudden spikes or irregular fluctuations. Further, anomalies may introduce unusual harmonics or resonance frequencies in sound and vibration signals, indicating specific fault frequencies associated with the problem. Furthermore, changes in spectral characteristics and increased noise levels during operation are indicative of potential issues within the machinery. Additionally, anomalies may lead to changes in the thermal behavior of the affected components. These changes can result in abnormal temperature fluctuations, increased heat generation, or localized hotspots within the machinery. By monitoring and analyzing these variations, maintenance technicians, engineers, and/or specialists can identify emerging problems early, enabling proactive maintenance interventions to prevent costly downtime and repairs.

An embodiment of the present disclosure discloses a noise, vibration, and temperature analysis system and method for detecting anomalies in mechanical components. The system includes a receiver module to receive sound data, vibration data, and temperature data from the mechanical components in real-time in various operational conditions. Further, the system includes a synthesizer to generate synthesized sound data from the received sound based on varying noise environments by performing pitch changing, temporal stretching, and noise injection. The synthesizer is configured to convert the vibration data to an audio signal and corresponding sound data, such that the received sound data and the sound data corresponding to the vibration are analyzed together. Additionally, the synthesizer enhances dataset by applying one or more data augmentation techniques on both received data and synthetic data.

In an embodiment, the system includes a pre-processor to preprocess the received data, and the synthesized sound data to remove background noise and thermal shifting. The preprocessing is performed of normalization, filtering, equalization, and noise reduction. Further, the preprocessing includes utilizing Non-Local Means (NLM) filtering to reduce noise, such that target signal is determined by locating and processing related audio patches. Furthermore, the preprocessing includes reducing noise signals by statistical models including Hidden Markov Models (HMMs) and Gaussian Mixture Models (GMMs). Moreover, the preprocessing includes changing audio spectrum information to balance desired audio signal and undesirable background sound by utilizing high-pass, low-pass, band-pass, and notch filters.

In an embodiment, the system includes a feature extraction module to extract one or more features from the preprocessed received data and the preprocessed synthesized data. The one or more features are associated with sinusoidal modulation features, time domain features, frequency domain features, time-frequency domain features, rhythm and temporal features, statistical features, Mel-Frequency Cepstral Coefficients (MFCCs), harmonic and timbral features, and waveform shape features.

In an embodiment, the system includes an anomaly identification module to identify anomalies in the mechanical components based on the extracted one or more features by employing one or more Machine Learning (ML) models. The one or more ML models include Deep Neural Networks (DNN), Convolutional Neural Networks (CNNs), Support Vector Machines (SVMs), and Recurrent Neural Networks (RNNs). Further, the anomaly identification module is configured to identify a solution for the identified anomaly by employing the one or more ML models.

In an embodiment, the system includes a rendering module to render the identified anomaly in the mechanical components to a user. Further, the rendering module also renders the identified solution to the user.

In an embodiment, the method includes receiving sound, vibration, and temperature data from the mechanical components in real-time in various operational conditions. Further, the method includes generating synthesized sound data from the received sound based on varying noise environments by performing pitch changing, temporal stretching, and noise injection. Furthermore, the method includes preprocessing the received data and the synthesized sound data to remove background noise and thermal shifting. Moreover, the method includes extracting one or more features from the preprocessed received data and synthesized sound data. Additionally, the method includes identifying anomaly in the mechanical components based on the extracted one or more features by employing one or more Machine Learning (ML) models. In an embodiment, the method includes rendering at least the identified anomaly in the mechanical components to a user.

The features and advantages of the subject matter hereof will become more apparent in light of the following detailed description of selected embodiments, as illustrated in the accompanying FIGURES. As one of ordinary skills in the art will realize, the subject matter disclosed is capable of modifications in various respects, all without departing from the scope of the subject matter. Accordingly, the drawings and the description are to be regarded as illustrative.

### BRIEF DESCRIPTION OF THE DRAWINGS

The present subject matter will now be described in detail with reference to the drawings, which are provided as illustrative examples of the subject matter to enable those skilled in the art to practice the subject matter. It will be noted that throughout the appended drawings, features are identified by reference numerals. Notably, the FIGURES and examples are not meant to limit the scope of the present subject matter to a single embodiment, but other embodiments are possible by way of interchange of some or all the described or illustrated elements and, further, wherein:

FIG. 1 illustrates an environment for detecting anomalies in mechanical components, utilizing sound, vibration, and temperature analysis, in accordance with an embodiment of the present disclosure.

FIG. 2 illustrates a block diagram of an anomaly detection system for detecting anomalies in mechanical components, utilizing sound, vibration, and temperature analysis.

FIG. 3 illustrates an exemplary block diagram for a machine learning (ML) model training, in accordance with an embodiment of the present disclosure.

FIGS. 4A-4F illustrate various exemplary implementations of a fault diagnosis system application, in accordance with an embodiment of the present disclosure.

FIG. 5 is a flow chart of a method for detecting anomalies in mechanical components, utilizing sound, vibration, and temperature analysis, in accordance with an embodiment of the present disclosure.

FIG. 6 illustrates an exemplary computer system in which or with which embodiments of the present disclosure may be utilized.

### DETAILED DESCRIPTION OF THE EMBODIMENTS

The detailed description set forth below in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form to avoid obscuring the concepts of the presently disclosed method and system.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection. Based on the disclosure provided herein, one of ordinary skills in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

It will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

The present disclosure relates to the field of vehicle diagnosis, and in particular, relates to an anomaly analysis system and method for detecting anomaly in mechanical components.

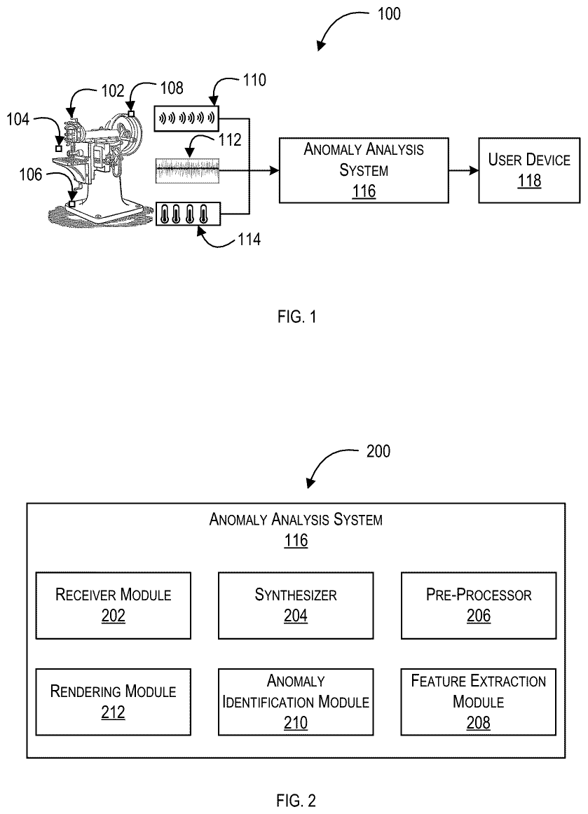

FIG. 1 illustrates an environment 100 for detecting anomalies in mechanical components, utilizing sound, vibration, and temperature analysis, in accordance with an embodiment of the present disclosure. In an embodiment, the environment 100 includes a machine 102, one or more sensors (such as an audio-capturing sensor 104, a vibration-capturing sensor 106, a temperature measuring sensor 108, etc.), an anomaly analysis system 116, and a user device 118. The machine 102 may represent any mechanical equipment and or mechanical components which may be susceptible to wear, stress, or potential failure. The machine 102 may include, but is not limited to, industrial machinery, automobiles, planes, turbines, solar panels, healthcare equipment, etc.

In an embodiment, the one or more sensors may be positioned strategically within the machine or its immediate vicinity, to provide a comprehensive snapshot of the operational dynamics, detecting even the slightest deviations from the norm. Further, the one or more sensors may collect audio data 110, vibration data 112, and temperature data 114 during operational tests and diverse operating conditions. Furthermore, the one or more sensors may be positioned to monitor components like conveyor belts, pumps, motors, and hydraulic systems, enabling the early identification of faults that could lead to production downtime. For automobiles, the one or more sensors may be integrated into vehicles to monitor engine, transmission, suspension, and braking systems to detect abnormalities such as engine misfires, worn-out bearings, or brake issues, enhancing vehicle safety and performance. Healthcare equipment, including MRI machines and X-ray devices, may be outfitted with the one or more sensors to detect anomalies during medical procedures, ensuring patient safety and diagnostic accuracy.

In an embodiment, the audio-capturing sensor 104 may include a microphone, hydrophones, etc. Further, the audio-capturing sensor 104 may be tailored to capture a wide range of acoustic signals with high fidelity and accuracy. Furthermore, the audio-capturing sensor 104 may detect subtle variations in air pressure caused by sound waves, enabling precise recording of auditory data emanating from the machinery. Moreover, frequency of capture audio waveform may be in a range of 20 hz to 45 khz. The vibration-capturing sensor 106 may include an accelerometer, vibrometers, seismic sensors, etc. Further, the vibration-capturing sensor 106 may detect mechanical vibrations across various frequencies and amplitudes. Furthermore, the vibration-capturing sensor 106 may accurately measure changes in acceleration, velocity, and displacement within the machinery, providing valuable insights into its mechanical behavior and health status. The temperature measuring sensors 108 may include a thermocouple, an infrared sensor, etc. Further, the temperature measuring sensors 108 may measure the temperature of mechanical components under various operational conditions, enhancing the detection and analysis of potential anomalies.

In an embodiment, the audio data 110 may be captured with the audio capturing sensor 104. The vibration data 112 may be captured with the vibration capturing sensor 106. The temperature data 114 may be captured with the temperature measuring sensor 108. The captured audio data 110, vibration data 112, and temperature data 114 may be transmitted to the anomaly analysis system 116 through various means, depending on the specific requirements and constraints of the environment. In a scenario, a built-in transmitter may be utilized directly to wirelessly transmit audio data 110, vibration data 112, and temperature data 114 to the anomaly analysis system 116. For instance, the audio-capturing sensor 104, vibration-capturing sensor 106, and temperature-measuring sensor 108 may utilize Bluetooth or Wi-Fi protocols to establish a direct connection with the anomaly analysis system 116. In another scenario, the captured audio data 110, vibration data 112, and temperature data 114 may be transmitted through wired network communication protocols such as Ethernet or Modbus. In yet another scenario, the captured audio data 110, vibration data 112, and the temperature data 114 may be transmitted directly to a cloud-based server. Each of the one or more sensors may communicate with cloud-based platforms using protocols like MQTT (Message Queuing Telemetry Transport) or HTTP (Hypertext Transfer Protocol), sending data to designated cloud storage or processing services.

In an embodiment, the anomaly analysis system 116 may access the cloud-based data repository to retrieve sensor information and perform analysis remotely. In yet another scenario, a combination of the above methods may be employed to optimize data transmission efficiency and reliability. In an embodiment, the audio data 110 and vibration data 112 may be continuously transmitted to the anomaly analysis system 116, and/or be initially collected and aggregated before transmitting to the anomaly analysis system 116. It may be understood that the transmitter may correspond to any of the existing wireless modules (e.g., Bluetooth module, Infrared module, ZigBee module, or the like) for transmitting the captured audio data 110 and vibration data 112 to the anomaly analysis system 116.

In an embodiment, the anomaly analysis system 116 may analyze the captured sound, vibration, and temperature data to identify a deviation from normal operating conditions. In an embodiment, the anomaly analysis system 116 may continuously capture the sound, vibration, and temperature data emitted by the machine during operation. Further, the anomaly analysis system 116 may identify the deviation in real-time. Furthermore, the anomaly analysis system 116 may, based on the identified deviations, identify potential faults or anomalies within the mechanical components. Based on the identified faults or abnormalities, technicians or engineers may discern abnormal patterns associated with a myriad of faults, ranging from engine misfires to worn-out bearings and brake malfunctions.

In an embodiment, the user device 118 may render the output of the anomaly analysis system 116. The user device 118 may allow a user to visualize detected anomalies, review diagnostic information, and take appropriate actions based on the anomaly analysis system 116 recommendations. The user device 118 may be, but is not limited to, a smartphone, a Personal Assistant Device (PDA), a PC, a tablet, a laptop, a smart watch, a VR-AR device, and so on. The user device 118 may be any equipment that provisions the user 102 to interact with the anomaly analysis system 116. The user may connect with the user device 118 to access the anomaly analysis system 116. Further, the user device 118 may receive user input from the user. In an embodiment, the user device 104 may include an interface that enables the presentation of the detected anomalies, and diagnostic information to the user. The interface may include but is not limited to, a display screen, a microphone, a speaker, a camera, and so on. In an embodiment, the user input from the user may be in the form of a text data, voice input, image data, video data, and so on. Accordingly, the communication network 110 may include, without limitation, a direct interconnection, a Local Area Network (LAN), a Wide Area Network (WAN), a wireless network (e.g., using Wireless Application Protocol), the Internet, and the like.

FIG. 2 illustrates a block diagram 200 of the anomaly analysis system 116 for detecting anomalies in mechanical components, utilizing sound, vibration, and temperature analysis, in accordance with an embodiment of the present disclosure. In an embodiment, the anomaly analysis system 116 may include a receiver module 202, a synthesizer 204, a pre-processor 206, a feature extraction module 208, an anomaly identification module 210, and a rendering module 212. The receiver module 202, the synthesizer 204, the pre-processor 206, the feature extraction module 208, the anomaly identification module 210, and the rendering module 212 may be communicatively coupled to a memory and a processor of the automated anomaly analysis system 116. The processor may control the operations of the synthesizer 204, the pre-processor 206, the feature extraction module 208, the anomaly identification module 210, and the rendering module 212. In an embodiment of the present disclosure, the processor and the memory may form a part of a chipset installed in the automated system anomaly analysis system 116. In another embodiment of the present disclosure, the memory may be implemented as a static memory or a dynamic memory. In an example, the memory may be internal to the automated anomaly analysis system 116, such as an onside-based storage. In another example, the memory may be external to the automated anomaly analysis system 116, such as cloud-based storage. Further, the processor may be implemented as one or more microprocessors, microcomputers, digital signal processors, central processing units, state machines, logic circuitries, and/or any devices that manipulate signals based on operational instructions.

In an embodiment, the receiver module 202 may receive sound data, vibration data, and temperature data from the mechanical components in real-time in various operational conditions. Further, the receiver module 202 may receive a real-time dataset in a form of authentic audio recordings captured from auto repair shops, maintenance facilities, and pertinent outdoor settings. The audio recordings may be captured in the .wav format from mechanical components in various operational conditions. For a person skilled in the art, it is understood that other audio formats, including but not limited to .mp3, .flac, .aiff, .ogg, and .m4a, may also be employed based on the specific needs and constraints of the anomaly analysis system 116. Further, audio recordings may be captured in any additional formats that may be utilized to meet the requirements of different scenarios and operational environments.

In an embodiment, the sound data, vibration data, and temperature data from mechanical components may be utilized to identify the abnormal patterns that may indicate anomalies such as engine misfires, worn-out bearings, suspension problems, or brake issues. High-quality recording equipment may be used to capture audio data with clarity and precision. Vibration sensors may be utilized to record the mechanical vibrations from various mechanical components. Temperature sensors, such as thermocouples and infrared sensors, may be employed to measure the thermal conditions of the components. Further, the temperature sensors may provide accurate temperature readings over a wide range, detecting variations that could signify issues like overheating or thermal stress.

In an embodiment, the synthesizer 204 may generate synthesized sound data from the received sound data based on varying noise environments by performing pitch changing, temporal stretching, and noise injection techniques. The pitch changing, temporal stretching, and noise injection techniques may enable the synthesizer 204 to simulate diverse acoustic conditions, such as those found in urban, rural, indoor, or industrial settings. For instance, the synthesizer can replicate complex auditory landscapes, including urban traffic noises or industrial machinery sounds, thereby enhancing the accuracy of anomaly detection.

In an embodiment, pitch changing may include altering the frequency of the sound data to simulate different acoustic conditions. By modifying the pitch, the synthesized dataset may reflect variations in the perceived tone and pitch of the sounds associated with different operational states or environmental settings, such as the higher pitch of machinery in a high-speed mode or the lower pitch in a low-speed mode. In an embodiment, the temporal stretching may refer to adjusting the duration or speed of the sound data without affecting pitch. The temporal stretching technique may facilitate the synthesized dataset to mimic variations in sound duration that may occur due to changes in machine speed or operational rhythm. For instance, if the machine 102 operates at different speeds during operation, temporal stretching may replicate the elongation or contraction of sound waves to accurately represent the changes. In an embodiment, the noise injection may include adding artificial noise to the sound data to simulate real-world acoustic conditions. The noise injection technique may help the synthesized dataset to include background noise elements that might be present in various environments, such as ambient sounds from machinery, human activity, or environmental factors. By incorporating noise injection, the anomaly detection system 116 may enhance the accuracy of anomaly detection by creating more realistic sound scenarios.

In an embodiment, the diverse acoustic conditions may encompass a broad spectrum of acoustic scenarios influenced by factors such as location, time, surrounding activities, and environmental conditions. For example, in urban settings, sound data can be elevated due to factors like traffic, construction, industrial operations, and human activities. Further, the sound data may result in a complex auditory landscape characterized by a continuous hum of other vehicles, honking horns, and machinery. Similarly, rural areas environment may have lower background sound levels but still contend with natural sounds such as wind, wildlife, and agricultural activities. Indoor environments present their own set of challenges, with echoes, reverberations, and equipment noise contributing to the acoustic complexity. Likewise, the machine industry environments within industrial settings are characterized by specific acoustic conditions influenced by factors such as machinery operation, manufacturing processes, and facility layout. In industrial environments, the sound data can be diverse and dynamic, reflecting the complex interplay of industrial activities. For instance, within a factory floor, the noise environment may be dominated by the rhythmic hum of machinery, clanking of metal components, and the whirring of conveyor belts. Additionally, in areas where heavy machinery is in use, such as manufacturing plants or processing facilities, the sound data may include low-frequency vibrations and reverberations that resonate throughout the environment. Moreover, the noise environment in a machine industry setting can vary depending on factors such as the type of manufacturing process, the size of the facility, and the proximity of machinery to each other. In larger industrial complexes, sound data may also be influenced by external factors such as nearby transportation routes or adjacent industrial operations.

In an embodiment, the synthesized sound dataset generated by the synthesizer 204 may adapt to the unique noise environments encountered during the operation of mechanical components. By adapting to the varying noise environments, the synthesized sound dataset may enhance the accuracy of anomaly detection in mechanical components. The adaptation may include modifying the synthesized sound data to reflect the specific acoustic characteristics and background noise levels that are present in different operational contexts. For example, in a noisy industrial setting with machinery, the synthesized dataset may incorporate sounds and noise patterns that mimic the actual conditions of the environment, including the hum of equipment and machinery vibrations. Conversely, in a quieter rural setting, the synthesized data may include subtler background noises such as wind or distant wildlife. By tailoring the synthesized sound data to match these varying noise environments, the anomaly detection system 116 may detect the anomalies more accurately.

In an embodiment, the synthesizer 204 may be configured to convert the vibration data to an audio signal and corresponding sound data, such that the received sound data and the sound data corresponding to the vibration data are analyzed together. Converting the vibration data into sound data may enable multimodal analysis, where both auditory and visual cues are utilized simultaneously. Further, the synthesizer 204 may enhance the dataset (fusion of audio, vibration, and temperature data) by applying one or more data augmentation techniques on both the received data and synthetic data. Furthermore, the synthesizer 204 may modify the frequency of the sound data and replicate the pitch variations observed in diverse noise environments to account for differences in tonal characteristics and frequency distributions across different acoustic settings. Moreover, the synthesizer 204 may alter the timing and duration of sound and vibration signals. By stretching or compressing the temporal dimension of the data, the synthesizer 204 may simulate the effects of time-varying noise environments, including fluctuations in intensity, duration, and temporal patterns. Additionally, the synthesizer 204 may incorporate noise injection techniques to introduce background noise or interference into the synthesized data to mimic the ambient noise present in real-world environments, including environmental factors such as urban traffic, industrial machinery, or natural sounds. In an embodiment, the synthesizer may utilize all the techniques in combination to generate synthesized sound data that closely resemble the characteristics of varying noise environments encountered during the operation of mechanical components. The synthesized data serves may as training data for the anomaly detection system 116, enabling robust and accurate performance across a wide range of acoustic conditions.

In an embodiment, various synthesis techniques may be employed to enhance the capabilities of the anomaly analysis system 116 for evaluating and classifying synthetically created sound data, thereby improving the accuracy of anomaly detection. For example, additive synthesis may combine sine waves to create complex sounds, and subtractive synthesis, may manipulate sounds by frequency filtering. Furthermore, FM synthesis may be utilized for potentially producing distinctive bell-like tones, and Wavetable synthesis may enable the generation of evolving sounds. Granular Synthesis may offer a means to potentially construct abstract soundscapes, while Physical Modelling synthesis may simulate the acoustic behavior of real-world objects. Additionally, Sample-Based synthesis may contribute to producing realistic auditory effects. The synthesis methods, alongside advancements in neural networks and AI-based synthesis, may potentially form integral components of the system's capacity to analyze and categorize synthesized sound data accurately, thus potentially enhancing fault diagnosis accuracy.

In an embodiment, the synthesizer 204 may remove captured private conversations or personal details. Robust encryption methods and secure storage protocols may be utilized to safeguard sensitive data from unauthorized access or breaches. Additionally, anonymization techniques should be applied to remove any personally identifiable information, ensuring the privacy of the individuals involved.

In an embodiment, the pre-processor 206 may preprocess the received data and synthesized sound data to remove background noise and thermal shifting. The received data may be the sound data, vibration data, and temperature data, received via the receiver module 202, from the mechanical components in real-time in various operational conditions. The preprocessing performed of normalization, filtering, equalization, and noise reduction. Further, the preprocessing may include utilizing Non-Local Means (NLM) filtering to reduce noise, such that target signal is determined by locating and processing related audio patches. Furthermore, the preprocessing may further include reducing noise signals by statistical models including Hidden Markov Models (HMMs) and Gaussian Mixture Models (GMMs). Moreover, the preprocessing may include changing audio spectrum information to balance desired audio signal and undesirable background sound by utilizing high-pass, low-pass, band-pass, and notch filters.

In an embodiment, the pre-processor 206 may preprocess only the received data, excluding the synthesized sound data. The preprocessing may include removing background noise and addressing thermal shifting in the received data to ensure its quality and accuracy. The synthesized sound data, which is generated to represent various noise environments and operational conditions, may not require preprocessing as the synthesized sound data may already be tailored to include different acoustic scenarios for enhanced anomaly detection.

In an embodiment, the pre-processor 206 may utilize background noise removal techniques such as Signal-to-Noise Ratio (SNR), Adaptive Filtering Techniques (AFT), Wavelet denoising, Hidden Markov Models categorize (HMMs) and Gaussian Mixture Models (GMMs), Non-Local Means (NLM) filtering, etc. may be utilized to remove the background noise. The SNR may be utilized to assess the balance between desired audio signals and undesirable background noise. To increase SNR, spectral subtraction may calculate and subtract noise patterns from audio sources. The AFT may be utilized to continuously adjust to changing noise characteristics in real time. Wavelet denoising may reduce noise while preserving important signal features. Non-Local Means (NLM) filtering may reduce noise while the target signal may be preserved by locating and processing related audio patches. To efficiently change audio spectrum information, audio filtering methods such as high-pass, low-pass, band-pass, and notch filters may be utilized.

In an embodiment, the pre-processor 206 may utilize high-pass filters to effectively eliminate low-frequency noise, such as rumble or hum, by allowing only frequencies above a designated cutoff to pass through. Conversely, low-pass filters may be employed to suppress high-frequency noise, maintaining precise control over audio bandwidth by permitting only frequencies below a specified threshold. Band-pass filters may isolate specific frequency ranges within audio signals, facilitating the extraction of instrument frequencies from complex, multi-instrument recordings. Additionally, the notch filter, also known as the band-stop filter, adeptly eliminates unwanted frequencies and narrowband interference by attenuating frequencies within a specified band while leaving others unaffected. Shelving filters may enable fine-tuned audio tonality adjustments, allowing for the boosting or attenuation of frequencies above or below a predetermined cutoff, proving invaluable in equalization (EQ) operations. Additionally, peaking filters may facilitate precise frequency adjustments within a narrow range centered on specific frequencies, addressing problematic resonances and accentuating or attenuating particular instrument frequency ranges in audio recordings.

In an embodiment, the normalization technique may ensure the high-quality audio output fundamental to the invention. Amplitude scaling may be employed to precisely control audio loudness, ensuring that the loudest part of the audio adheres to predefined maximum values without exceeding them, thereby preventing undesirable distortion due to amplitude clipping. Consistent volume levels may be prioritized, particularly vital when dealing with multiple audio files or segments, to eliminate abrupt changes in volume and enhance the overall auditory experience. The normalization algorithm may serve as a vigilant guardian against clipping, continuously monitoring and adjusting amplitudes in real-time to prevent breaches of digital boundaries. Dynamic range control may be skillfully utilized to fine-tune the loudness of audio tracks, making them suitable for a range of applications, including fault diagnosis in vehicles and machinery. In essence, normalization may assure the integrity, consistency, and exceptional quality of audio content, a critical aspect of the fault diagnosis system's innovative approach.

In an embodiment, trimming and silence removal of the audio may be performed to enhance the caliber of audio data. The trimming and silence removal may be performed when working with lengthy audio recordings and/or when isolating specific areas of interest becomes necessary. Further, the trimming and silence removal of the audio may clean up the audio, eliminating any unnecessary silence or extraneous material, and producing a more concise and insightful audio file. Silence detection may be performed using a mechanism to identify audio segments with amplitudes below a set threshold, indicating the presence of silence or almost silent intervals. The identification may break the audio into distinct chunks and separate relevant content from silent or unnecessary segments. The silent sections may methodically be eliminated thereafter to prepare the audio for analysis and use. The methodical elimination may not only enhance audio quality but also significantly reduce data size, facilitating effective data management, storage, and transmission. Further, the methodical elimination may enhance synthetically generated sound data, ensuring that it meets the high criteria of precision and efficiency required for precise fault detection and classification.

In an embodiment, the pre-processor 206 may ensure that the temperature data accurately reflects the true thermal state of the mechanical components, free from extraneous influences that could skew the analysis. Background noise, such as ambient temperature fluctuations or electromagnetic interference, may be filtered out to enhance the clarity and precision of the temperature readings. Thermal shifting, which can occur due to changes in environmental conditions or sensor drift over time, may be corrected to maintain consistent and reliable temperature measurements.

In an embodiment, the feature extraction module 208 may extract one or more features from the preprocessed received data and the preprocessed synthesized data. Further, extracting one or more features may include identifying and quantifying relevant characteristics of the data (preprocessed received data and the preprocessed synthesized data) that are indicative of potential anomalies or deviations from normal operating conditions. The extracted features may include statistical measures, frequency components, temporal patterns, or other attributes that provide insights into the behavior of the mechanical components under observation.

In an embodiment, the feature extraction module 208 may extract one or more features from the preprocessed received data and the synthesized data. The preprocessing of received data involves removing background noise and correcting for thermal shifts to improve data quality before feature extraction. In contrast, the synthesized data, which is generated by the synthesizer 204, may be utilized in its raw form for feature extraction without additional preprocessing.

In an embodiment, the feature extraction module 208 may extract one or more features from the preprocessed received data. The preprocessing of received data involves removing noise and correcting for thermal shifts, thereby enhancing the quality of the data before feature extraction. In contrast, the synthesized data, generated by the synthesizer 204 and without prepossessing, may be used in raw form for feature extraction. The decision to forgo preprocessing for synthesized data may be due to the reason that synthesized data created to mimic varying noise environments may not require cleaning or correction. By using synthesized data directly, the feature extraction module 208 may extract a broader range of signal characteristics and anomalies that may not be present in the preprocessed received data.

In an embodiment, the one or more features may be associated with sinusoidal modulation features, time domain features, frequency domain features, time-frequency domain features, rhythm and temporal features, statistical features, Mel-Frequency Cepstral Coefficients (MFCCs), harmonic and timbral features, and waveform shape features. The sinusoidal modulation feature may allow for precise audio signal generation and modification. Further, the sinusoidal modulation feature may include changing the frequency, amplitude, or phase of sinusoidal audio signal components. Furthermore, sinusoidal modulation techniques such as Amplitude modulation (AM), frequency modulation (FM), and phase modulation (PM), may produce synthetic sound data that closely resembles audio characteristics associated with faults in the real world.

In an embodiment, the time-domain features may comprehend fault-related audio patterns. The time-domain feature may include, but is not limited to, raw amplitude values, Root Mean Square Energy (RMSE), and Zero-Crossing Rate. Furthermore, the time domain feature may capture the temporal aspects of the data. In an embodiment, the frequency-domain features may provide insights into the spectral content of audio signals, aiding in the identification of fault-related frequency patterns. Techniques such as the Spectrogram, Pitch, Mel-Frequency Cepstral Coefficients (MFCCs), Chroma Features, Spectral Contrast, Spectral Centroid, Bandwidth, and Roll-off may be utilized for this purpose.

In an embodiment, temporal and frequency variations within the audio data may be analyzed using signal processing techniques like Short-Time Fourier Transform (STFT), Fast Fourier Transform (FFT), Gammatone Filterbank, and Wavelet Transform may be employed to analyze both temporal and frequency variations within audio data. The signal processing techniques may enhance the efficiency of fault detection by identifying transient and evolving faults. Further, the signal processing techniques may facilitate capturing both temporal and frequency-domain characteristics of the data (both received data and synthetic data), providing a more comprehensive analysis for detecting anomalies. The STFT may be used to perform localized time-frequency analysis, enabling to monitor how frequency components change over time. The FFT may offer an efficient means to break down the signal into its global frequency components, providing insights into overall frequency patterns. The Gammatone Filterbank may mimic the frequency analysis performed by the human auditory system, and provide fine-grained frequency resolution across different bands. The fine-grained frequency resolution may be crucial for identifying subtle frequency-related anomalies. The wavelet transform, may provide multi-resolution analysis, capturing both fine-grained temporal details and frequency characteristics, enabling the detection of transient or localized anomalies. In an embodiment, the signal processing techniques may facilitate anomaly analysis system 116 to detect both subtle and pronounced anomalies, ensuring precise identification of mechanical issues under various operational conditions.

In an embodiment, the rhythm and speed of sound data may be crucial for identifying anomalies and temporal patterns associated with faults. Techniques such as onset detection may assist in determining the timing of fault-related events. In an embodiment, statistical features such as Mean, Variance, Skewness, Kurtosis, and Standard Deviation may be utilized to describe the statistical properties of audio data. The statistical features may help in identifying deviations from the norm that could indicate potential problems. In an embodiment, acoustic qualities such as loudness, sharpness, roughness, and tonal features may enable the perception and evaluation of audio data from a human perspective. The perception and evaluation of audio data from a human perspective may help in identifying unexpected or potentially dangerous auditory cues associated with errors. In an embodiment, exploring the harmonic content and timbre of audio signals may provide valuable information on the distinctive acoustic signatures of errors. Further, harmonic content and timbre of audio signals may aid in fault detection and classification. In an embodiment, techniques such as Hidden Markov Models (HMMs) and Gaussian Mixture Models (GMMs) may be employed to model and categorize fault-related audio patterns. The categorize fault-related audio patterns may facilitate classifying and interpreting fault-related audio data effectively. In an embodiment, sinusoidal modulation in combination with other audio synthesis methods may produce intricate fault-related soundscapes.

In an embodiment, the feature extraction module 208 may transform raw data into a set of meaningful, representative attributes. The transformed data may reduce the dimension of data while retaining essential information. Extracting the relevant features of the data may enable efficient analysis, classification, and pattern recognition. Spectral features, including Spectral Centroid, Bandwidth, Contrast, and Roll-off, are integral to feature extraction. Further, the spectral features may enable the identification of specific frequency patterns associated with vehicle noise, providing insights into the energy distribution across frequency components. The specific selection and utilization of the spectral properties may contribute to the originality of the invention. In an embodiment, rhythm features, along with characteristics such as Spectral Centroid, Bandwidth, Contrast, and Roll-off, are vital for feature extraction. Further, the rhythm features may aid in identifying particular frequency patterns linked to machine noise, offering insights into the energy distribution across frequency components. The specific choice and utilization of the spectral properties may enhance the uniqueness of the invention. In an embodiment, time-domain features such as Root Mean Square (RMS) Energy, Entropy, and Duration complement the feature extraction process by directly characterizing waveform properties. Additionally, the incorporation of Cepstral Coefficients, particularly Linear Predictive Coding (LPC), provides alternative representations of the audio signal, thereby enhancing the diagnostic capabilities of the system, especially for exhaust or engine-related issues.

In an embodiment, the feature extraction module 208 may utilize Empirical Mode Decomposition (EMD) and audio fingerprinting to extract relevant features from the data (received data and synthesized data). The EMD may decompose complex signals into Intrinsic Mode Functions (IMFs), each representing distinct oscillatory patterns at various frequency bands. The signal decomposition may facilitate to capture of frequency variations and amplitude modulations inherent in the signals. The frequency variations and amplitude modulations may be indicative of subtle irregularities or shifts in the mechanical components' performance that may indicate the onset of faults or degradation.

In an embodiment, the feature extraction module 208 may utilize audio fingerprinting to extract key auditory features by generating a unique digital fingerprint of the audio signals produced by the machinery. The audio fingerprinting may facilitate quick matching and comparison of operational sounds against baseline patterns. Further, audio fingerprinting may help to detect anomalies based on deviations from expected behavior.

In an embodiment, the feature extraction module 208 may efficiently convert raw audio input into informative numerical representations, serving as a foundational step for subsequent analysis activities. As part of this process, Mel-frequency Cepstral Coefficients (MFCCs) calculation plays a critical role. The MFCCs may capture essential spectral features of audio signals, which may undergo segmentation into brief, overlapping frames. Power spectrum calculation, depicting energy distribution across various frequencies for each frame, may follow. A filter bank, mimicking the human auditory system's frequency sensitivity, may enhance perceptual realism by producing filter bank energies. Subsequently, the discrete cosine transform (DCT) may be applied to the logarithm of the filter bank energies to derive the MFCCs. Due to efficient spectral information condensation and dimensionality reduction, MFCCs may be highly effective in identifying speech sounds and other audio patterns.

In an embodiment, the feature extraction module 208 may utilize entropy and kurtosis to gain deeper insights into the signal dynamics. Entropy may quantify the complexity and unpredictability of the signal, providing a measure of randomness or disorder. Kurtosis may evaluate tailedness and/or sharpness of the signal probability distribution, reflecting the presence of outliers or significant deviations from the mean.

In an embodiment, the anomaly identification module 210 may identify anomalies in the mechanical components based on the extracted one or more features by employing one or more Machine Learning (ML) models. The one or more ML models may include Deep Neural Networks (DNN), Convolutional Neural Networks (CNNs), Support Vector Machines (SVMs), and Recurrent Neural Networks (RNNs). Further, the anomaly identification module may be configured to identify a solution for the identified anomaly by employing the one or more ML models.

In an embodiment, the DNN model may comprehend intricate fault-related audio characteristics, serving as a foundation for learning complex patterns and representations from the audio input. Further, the DNN model in combination with the CNNs, SVMs, and RNNs may create a robust and adaptable framework for audio classification and issue identification. The SVM may provide a reliable mechanism for binary classification problems, complementing the capabilities of the DNN. Further, the SVMs may identify classes within audio data, thereby enhancing accurate defect identification. The CNNs may enable the anomaly analysis system 116 to capture spatial and spectral patterns in the audio, particularly useful for analyzing fault-related features that manifest in specific frequency regions or time intervals. The RNNs advanced temporal modeling, may facilitate in identifying defects exhibiting specific temporal characteristics or trends across time. The defect identification may be advantageous in scenarios requiring sequential audio analysis, as RNNs can capture dependencies and contextual information.

In an embodiment, the anomaly identification module 210 may utilize an Ensemble Learning framework to enhance the accuracy and reliability of anomaly identification. The Ensemble Learning framework may aggregate predictions from multiple Machine Learning models, including Deep Neural Networks (DNNs) and Convolutional Neural Networks (CNNs). Further, the Ensemble Learning approach leverages the strengths of each model type to provide a robust and comprehensive analysis. DNNs may capture complex, non-linear relationships within the data, making them effective for identifying intricate patterns indicative of anomalies. CNNs may excel in analyzing spatial hierarchies and patterns, particularly in data with a grid-like structure, such as images or spectrograms. By combining the outputs of diverse models, the anomaly identification module 210 may reduce the likelihood of false positives and false negatives, resulting in a more accurate and reliable detection of mechanical anomalies. The integration of multiple models ensures that the system can handle various types of data and anomaly scenarios, thereby improving overall performance and robustness in real-world applications.

In an embodiment, the Machine Learning (ML) models may determine thresholds for similarity measures to enhance the accuracy of anomaly detection across varying operational conditions. Further, the ML models may be trained on a comprehensive dataset that includes a wide range of operational states of the mechanical components, covering both normal and anomalous conditions to understand and learn the typical patterns of similarity and dissimilarity within the data. In an embodiment, the ML models then compute similarity scores by comparing the one or more features to historical reference data. The computation may involve calculating key statistical metrics, such as mean, variance, and standard deviation, to understand the typical range and distribution of similarity scores. Based on the statistical distribution, the ML models may dynamically adjust the thresholds for similarity measures. The adjustment may ensure that the thresholds are responsive to changes in the data and operational conditions, rather than relying on fixed, static values. Continuously updating the thresholds to reflect the current data landscape may improve the accuracy and effectiveness of anomaly detection, ensuring that deviations from normal behavior are identified and addressed appropriately.

In an embodiment, the anomaly identification module 210 may employ similarity measurement techniques such as Dynamic Time Warping (DTW), Cosine Similarity, and Constant-Q Transform (CQT) techniques to determine data similarity and subsequently identify anomalies in mechanical components. The similarity measurement techniques may enable analyzing the complex data characteristics captured from sound, vibration, and temperature sensors more effectively.

In an embodiment, the DTW technique may be utilized by the ML model to measure the similarity between time-series data from mechanical components operating under various conditions. Further, DTW may non-linearly align the data sequences, and the ML model may identify similar patterns in the data even if there are temporal shifts or distortions, which may often be the case in real-world operational conditions.

In an embodiment, the ML model may employ Cosine Similarity to evaluate the similarity between the feature vectors extracted from the preprocessed data. The Cosine Similarity may measure the angle between two vectors in a multi-dimensional space, and provide a way to assess whether the patterns or trends in the data are similar, regardless of magnitudes. Further, Cosine Similarity may help detect anomalies that manifest as subtle shifts in the directional trends of the data rather than significant changes in magnitude.

In an embodiment, the ML may utilize Constant-Q Transform (CQT) to capture frequency-based characteristics of the data (particularly for sound and vibration signals). The CQT may be capable of analyzing a wide range of frequencies with high resolution, especially at lower frequencies, where many mechanical anomalies tend to manifest. By transforming the time-domain signals into the frequency domain, the ML model may detect subtle frequency variations that may indicate early-stage anomalies in the mechanical components.

In an embodiment, the ML models provide a comprehensive assessment of the data by utilizing the DTW for temporal alignment, Cosine Similarity for pattern comparison, and CQT for frequency analysis. In an embodiment the ML may employ one similarity measurement techniques. In an embodiment, the ML may employ more than one similarity measurement technique. In an embodiment, the ML may employ a combination of similarity measurement techniques to detect subtle and complex anomalies that may otherwise go unnoticed using traditional methods.

In an embodiment, K-Means clustering may be utilized to enhance the accuracy of fault detection and anomaly identification. The K-Means clustering algorithm may categorize data points by identifying and grouping patterns based on similarities, thereby allowing real-time classification of different operational states of the mechanical components.

In an embodiment, the anomaly identification module 210 may employ an adaptive thresholding method. The adaptive thresholding method may improve the accuracy and effectiveness of anomaly detection by dynamically adjusting detection parameters in response to the real-time statistical properties of the incoming data. Further, the adaptive thresholding method may include calculation of essential metrics such as the median absolute deviation (MAD) and the interquartile range (IQR) from both historical and real-time data. MAD may include measuring the dispersion around the median to set adaptive thresholds that respond to natural signal variability. IQR may aid in identifying outliers and adjusting thresholds to account for fluctuations in the data. By continually refining the thresholds based on evolving metrics, the anomaly identification module 210 may detect true anomalies while reducing the likelihood of false positives.

In an embodiment of the present invention, once the one or more features are extracted, the received audio, vibration, and temperature data may undergo data labeling and annotation. Each data point may be assigned meaningful labels and/or annotations based on extracted features. The data labels and/or annotations may provide essential information about the state or condition of the mechanical components corresponding to the captured signals. Further, the data labeling and annotation may be performed manually by human annotators, domain experts, or through automated algorithms. Human annotators may review the extracted features and assign labels based on expertise, while automated algorithms may utilize predefined criteria or machine learning techniques for annotation. Additionally, data augmentation techniques may be employed to enrich the labeled dataset, enhancing diversity and robustness. In an embodiment, the labeled data may be performed to train Machine Learning (ML) models, enabling the ML models to learn and recognize patterns indicative of faults or anomalies in mechanical components. By incorporating accurate labels and annotations, the trained ML models may effectively detect and diagnose faults in real-world scenarios, contributing to improved maintenance practices and operational efficiency in various industries.

In an embodiment, the anomaly identification module 210 may identify anomalies in the mechanical components utilizing unsupervised learning techniques and anomaly detection models such as Autoencoders and Isolation Forests to detect subtle deviations in the operational data of the components, which may indicate potential faults or failures. Autoencoders may learn compressed representations of normal operating conditions and identify anomalies by measuring reconstruction errors. Isolation Forests may include isolating observations through random partitioning and identifying anomalies as points that require fewer partitions to isolate due to rarity or deviation from the norm.

In an embodiment, the anomaly identification module 210 may incorporate deep learning models, such as Siamese networks or triplet loss models. The deep learning models may detect subtle similarities and anomalies by learning from pairs or triplets of examples. The Siamese networks may compare two sets of data by measuring the similarity between the feature representations. The triplet loss models may distinguish between similar and dissimilar data points.

In an embodiment, the one or more ML models may deliver a comprehensive and effective method for problem diagnostics based on noise, vibration, and temperature analysis. The integration of multiple models enhances accuracy and adaptability, enabling the anomaly analysis system 116 to excel across a spectrum of real-world situations, from monitoring industrial machinery to detecting anomalies in machine 102.

In an embodiment, the rendering module 212 may render the identified anomaly in the mechanical components to a user. Further, the rendering module 212 may render the identified solution to the user. The identified anomaly and the solution to the identified anomaly may be in a user-friendly format, facilitating easy interpretation and decision-making by operators or maintenance personnel. For example, the rendering module may incorporate a user interface with intuitive visualization tools, allowing users to access the detected anomalies and diagnostic information effectively. Furthermore, the rendering module 212 may render visualizations of the sound, vibration, and temperature data collected from the machinery or mechanical components. The visualizations may include spectrograms, waveforms, or time-frequency plots, providing users with detailed insights into the detected anomalies and their characteristics. Further, the visualizations may include, but are not limited to, interactive plots, heatmaps, and multi-dimensional scaling to provide a detailed view of the data's characteristics and relationships. Furthermore, the visualizations may enable the user to observe patterns and correlations within the data in an intuitive and accessible manner. Moreover, the visualizations may include integrated time-series decomposition and anomaly detection results to provide insights into temporal trends, seasonal variations, and outlier behavior. The integration of time-series decomposition and anomaly detection results may facilitate a deeper understanding of the data dynamics, aiding in the early identification of anomalies and operational deviations within mechanical components.

In an embodiment, the rendering module 212 may generate visual representations such as charts, graphs, or heatmaps to illustrate the anomalies clearly and contextually. For instance, a heatmap may highlight the specific areas of a machine where deviations occur, while time-series graphs can show how anomalies deviate from normal operational patterns over time. In an embodiment, the rendering module 212 may employ audio alerts to signal the presence of anomalies, using distinct sounds or alarms that vary in pitch or intensity based on the anomaly's severity. In an embodiment, the rendering module 212 may utilize interactive dashboards to offer detailed, real-time data views and diagnostic information, allowing users to delve deeper into the nature of the anomalies. In an embodiment, the rendering module 212 may generate comprehensive reports summarizing the anomalies, and potential causes. In an embodiment, the rendering module 212 may recommend actions to facilitate informed decision-making. In an embodiment, the rendering module 212 may utilize augmented reality (AR) or virtual reality (VR) technologies to provide immersive visualizations of the anomalies, enabling users to explore the mechanical components and issues in a more interactive and intuitive manner.

Moreover, the rendering module 212 may render real-time alerts or notifications to inform users about potential faults or abnormal conditions detected by the anomaly detection system. The alerts may be displayed prominently within the user interface or sent to users via email or SMS for immediate attention. Additionally, the rendering module 212 may include features for historical data analysis, allowing users to review past fault occurrences, diagnostic results, and maintenance actions taken. The historical data analysis may provide valuable insights into the performance trends of the machinery over time, enabling users to make informed decisions regarding maintenance schedules and resource allocation. Thus, empowering the users to proactively monitor and maintain mechanical components, ensuring optimal performance and reliability.

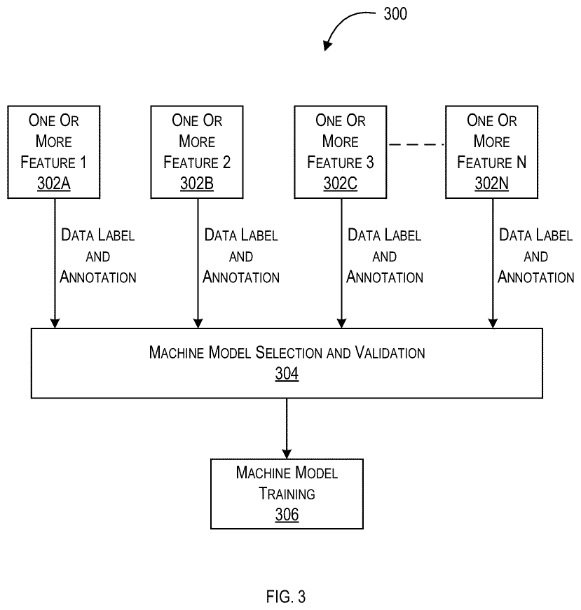

FIG. 3 illustrates an exemplary block diagram 300 for the machine learning (ML) model training, in accordance with an embodiment of the present disclosure. In an embodiment, the ML model may be trained on a dataset comprising labeled instances of normal and faulty audio, vibration, and temperature patterns to learn the distinguishing features of various fault conditions. One or more features of noise, vibration, and temperature data, such as one or more feature 1 302A, one or more feature 2 302B, one or more feature 3 302C, . . . one or more feature N 302N, (here forth also known as one or more features 302) are data labeled and annotated. The labels and annotations may be provided in meaningful descriptions or classifications for each data point based on the one or more features 302. Subsequently, ML models may be chosen and validated, shown by block 304, using the labeled dataset. Upon identifying appropriate models, ML may be trained (shown by block 306) using the labeled data to refine their parameters for precise fault detection.

In an embodiment, the ML model may be trained to process the audio, vibration and temperature data to analyze the extracted one or more features. Furthermore, the ML model may utilize domain-specific knowledge to enhance anomaly detection accuracy, such as understanding the typical noise profiles associated with specific mechanical components or subsystems. The ML model may compare the extracted one or more features with those learned during training to identify deviations from normal operating conditions indicative of potential faults. Further, the ML model may employ ensemble techniques, combining multiple algorithms or models to enhance fault identification accuracy. For example, a combination of deep neural networks, support vector machines, and decision trees may be used to achieve robust fault detection across different types of machinery and fault conditions. Overall, the ML system serves as a powerful tool for automatically detecting and diagnosing faults in mechanical components based on audio, vibration, and temperature analysis, thereby enabling proactive maintenance and minimizing downtime.

In an embodiment, the anomaly analysis system 116 may integrate Hidden Markov Models (HMMs) and Music Information Retrieval (MIR), to detect and diagnose faults in vehicles, machinery, and equipment by analyzing synthetically generated sound data. The HMMs may be utilized for identifying recurring acoustic patterns in machine operations and the MIR may aid in fault detection and classification.

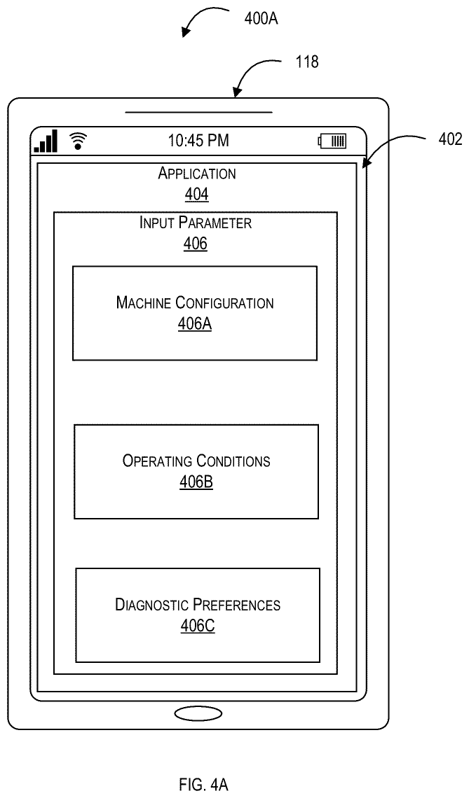

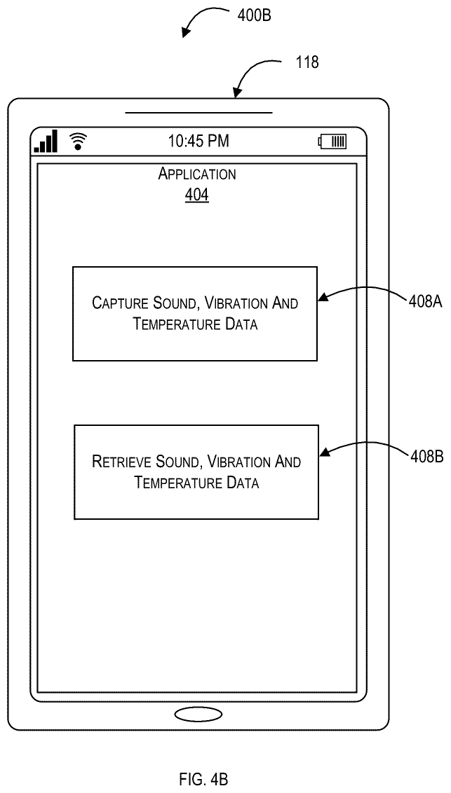

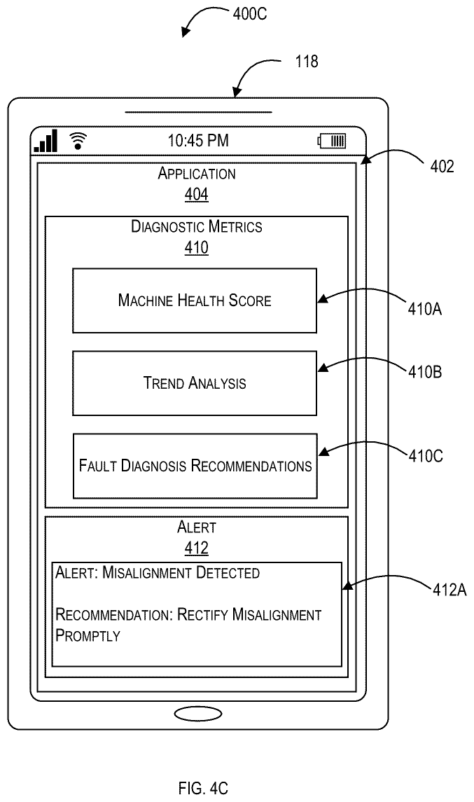

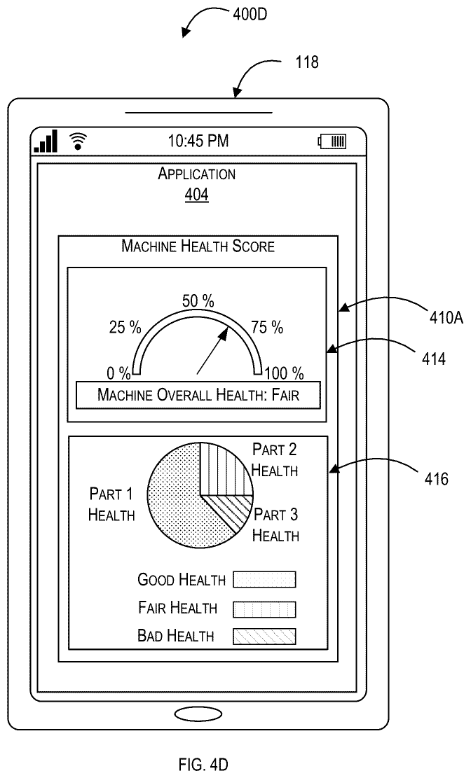

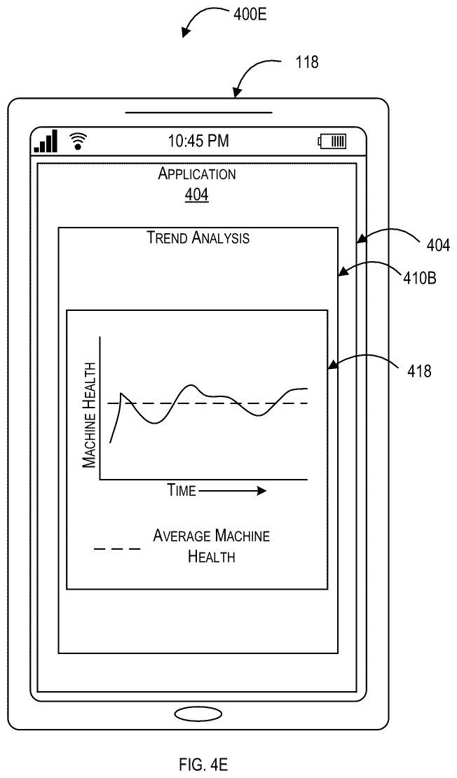

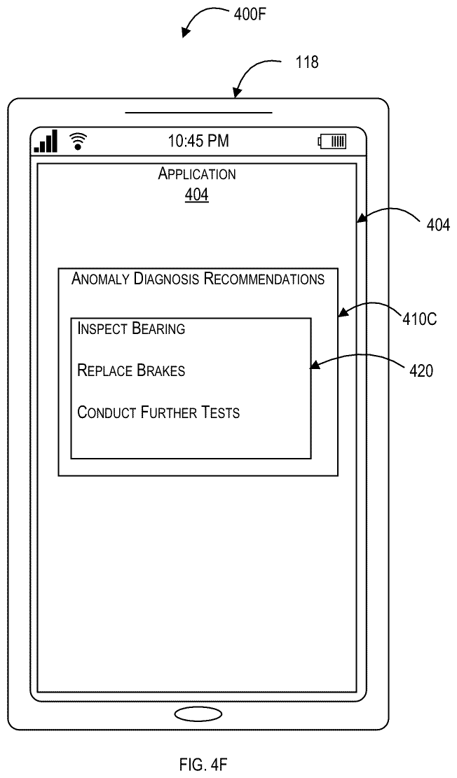

FIGS. 4A-4C illustrate various exemplary implementations 400A, 400B, 400C, 400D, 400E and 400F of an anomaly diagnosis application 404, in accordance with an embodiment of the present disclosure. In some embodiments, the user may log into a user device 114, having an interface 402, such as a mobile phone, or dashboard of the machine, and access the anomaly diagnosis application 404 for detecting anomalies in mechanical components. Further, the interface 402 may be accessible via a smartphone application or web browser. Through the application 402, the user may input relevant parameters 406 to enhance the functionality and effectiveness of the fault diagnostic system. The input relevant parameters 406 may include, but not limited to, machine configuration 406A, operating conditions 406B, maintenance history, sensor configuration, diagnostic preference 406C, etc. The machine configuration details 406A, may include model number, serial number, installation date, operating environment, etc., to tailor the anomaly analysis to the unique characteristics of the machine 102. The operating conditions 406B may include humidity, load capacity, speed, and duration of operation, helping the system adjust its analysis algorithms to account for variations in performance under different conditions. Furthermore, the user may provide maintenance history, such as repairs, replacements, and inspections, enabling the system to identify recurring issues and assess the effectiveness of previous maintenance actions. Moreover, the sensor configuration parameters, such as sensor type, placement, sensitivity, and sampling frequency, may ensure optimal data capture for accurate fault detection and analysis. Additionally, diagnostic preferences 406C, such as thresholds, alert notifications, and reporting formats, allow users to receive tailored insights aligned with their specific needs and operational requirements. In an embodiment, the anomaly diagnosis application 404 may retain the relevant input parameters 406 for subsequent utilization.

In an embodiment, as shown by FIG. 4B, the fault diagnosis application 404 may allow the user to choose from capturing sound, vibration, and temperature data, shown by 408A, directly through real-time capturing mechanisms and/or by retrieving sound, vibration, and temperature data, as shown by 408B, from cloud-based storage or pre-recorded datasets. Alternatively, the application may access stored data from cloud repositories or recorded datasets, which could contain historical information or previously collected samples.

In an embodiment, upon capturing and/or receiving the sound, vibration, and temperature data, the interface 402 may present diagnostic metrics 410 and alerts 412 to users. The diagnostic metrics 410 may provide users with valuable insights into the condition of the machinery. Further, the diagnostic metrics 410 may include machine health scores 410A, trend analyses 410B, and fault diagnosis recommendations 410C. The machine health score 410A may be a numerical assessment of the overall health and condition of the machinery based on the analysis of sensor data and detection of anomalies or irregularities. Further, the machine health score 410A may be based on patterns and deviations from normal behavior. Furthermore, the machine health score 410A may quantify the degree of deviation of a data point or set of data points from the expected or typical behavior of the machinery being monitored. The higher anomaly scores may suggest that the data points are within normal operating parameters, while lower scores may, indicate a higher likelihood of the presence of anomalies or potential faults. The numerical values to the severity of anomalies may facilitate users in prioritizing tasks based on the level of risk posed to the machinery's performance, safety, and reliability.

In some embodiments, the machine health score 410A may have threshold markers to indicate different health levels, such as Good, Fair, or Poor, as shown in FIG. 4D. For example, the machine health score 410A may show the overall health of the machine as fair, as shown by 414 and also show the health conditions of all the monitored parts, as shown by 416. Additionally, the machine health score 410A may be trended over time to track changes in machinery health and performance, to facilitate proactive maintenance strategies and predictive maintenance interventions.

In an embodiment, the trend analysis 410B may include examining historical data trends over time to identify patterns, anomalies, or shifts in machinery behavior that may indicate underlying issues or potential faults, as shown by FIG. 4E. The trend analysis 410B, may identify gradual changes or sudden deviations from normal operating conditions, which could signal emerging problems or deteriorating performance. For example, trend analysis 410B may reveal a gradual increase in vibration levels in a particular component over several weeks, suggesting potential wear or misalignment issues. Further, the trend analysis 414 may predict future performance trends or anticipate potential failure modes based on historical data patterns. By identifying trends associated with specific types of failures or maintenance events, the application may suggest schedule maintenance activities or implement corrective measures before significant issues arise. Furthermore, the trend analysis 410B results may be presented graphically, showing historical data trends alongside current readings and threshold values, as shown by 418. The visual representation allows users to easily interpret the data and identify any concerning trends or outliers. Moreover, the trend analysis 410B may enable proactive maintenance strategies by identifying emerging issues and predicting future machinery behavior. By leveraging historical data trends, the system can optimize machinery performance, reduce downtime, and minimize costly repairs.

In an embodiment, the anomaly diagnosis recommendations 410C may provide recommendations tailored to the specific issues identified in the machinery 102, as shown in FIG. 4F. The anomaly diagnosis recommendations 416 may be based on the machine health score 410A and/or trend analysis 410B. Further, the anomaly diagnosis recommendations 410C may include tasks such as inspecting and lubricating bearings, replacing worn-out parts (brakes), and/or may recommend conducting further tests, as shown by 420. Furthermore, the anomaly diagnosis recommendations 410C may indicate the urgency and/or priority of each recommendation, helping users prioritize maintenance tasks based on the severity of the detected issues. Additionally, fault diagnosis recommendations 410C may include guidance on diagnostic procedures, such as conducting further tests or inspections to pinpoint the root cause of the detected anomalies. Also, the fault diagnosis recommendations 410C may include using diagnostic equipment or techniques to validate the initial findings and ensure the accuracy of the diagnosis.

In an embodiment, the interface may also provide contextual information alongside diagnosis recommendations. The contextual information may include historical data on similar faults, recommendations from equipment manufacturers or industry standards, and relevant documentation or guidelines. In an embodiment, alert 412 may offer intuitive representations of potential faults or deviations from normal operation. Moreover, real-time alerts may promptly notify users of critical issues, empowering them to take immediate action. For example, the alert 212 may notify the user of a misalignment and may recommend the user to promptly rectify the alignment, as shown by 412A.

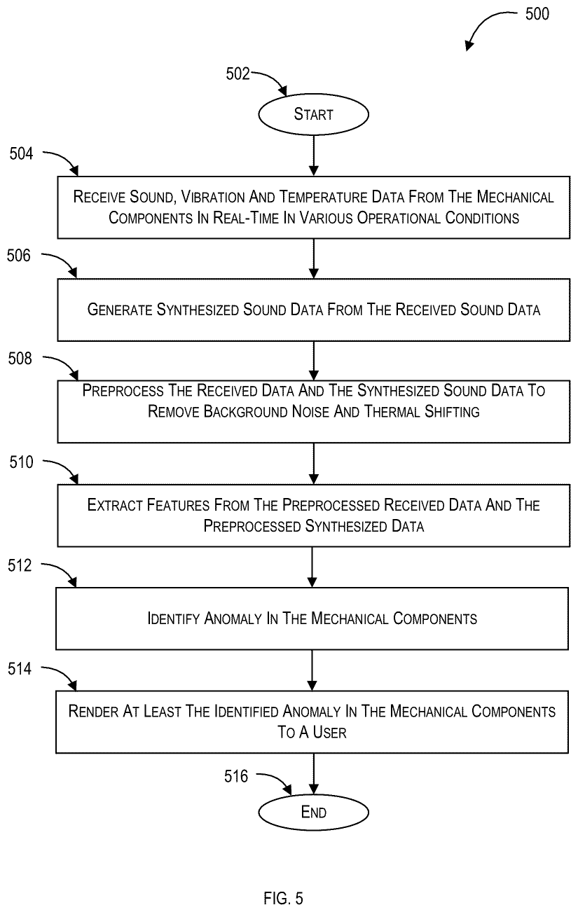

FIG. 5 is a flow chart 500 of a method for detecting anomalies in mechanical components, utilizing sound, vibration, and temperature analysis, in accordance with an embodiment of the present disclosure. The method starts at step 502. At first, sound, vibration, and temperature data from the mechanical components in real-time in various operational conditions may be received, at step 504. The audio recordings may be captured in the .wav format from mechanical components in various operational conditions. For a person skilled in the art, it is understood that other audio formats, including but not limited to .mp3, .flac, .aiff, .ogg, and .m4a, may also be employed based on the specific needs and constraints. Further, audio recordings may be captured in any additional formats that may be utilized to meet the requirements of different scenarios and operational environments. By capturing sound, vibration, and temperature data from mechanical equipment, the proposed approach identifies the abnormal patterns that may indicate faults such as engine misfires, worn-out bearings, suspension problems, or brake issues. High-quality recording equipment may be used to capture audio data with clarity and precision. Vibration sensors may be utilized to record the mechanical vibrations from various mechanical components. Temperature measuring sensors may be used to measure the temperature of various mechanical components.

Upon receiving the sound, vibration, and temperature data from the mechanical components, synthesized sound data from the received sound data may be generated, at step 506. The synthesized sound data may be based on varying noise environments by performing a pitch changing, temporal stretching, and noise injection. The varying noise environments may include diverse acoustic conditions encountered during the operation of mechanical components. The diverse acoustic conditions may encompass a broad spectrum of acoustic scenarios influenced by factors such as location, time, surrounding activities, and environmental conditions.

Next, at step 508, the synthesized sound data, vibration data, and temperature data may be preprocessed to remove background noise and thermal shifting. The preprocessing is performed of normalization, filtering, equalization, and noise reduction. Further, the preprocessing includes utilizing Non-Local Means (NLM) filtering to reduce noise, such that target signal is determined by locating and processing related audio patches. Furthermore, the preprocessing further includes reducing noise signals by statistical models including Hidden Markov Models (HMMs) and Gaussian Mixture Models (GMMs). Moreover, the preprocessing includes changing audio spectrum information to balance desired audio signal and undesirable background sound by utilizing high-pass, low-pass, band-pass, and notch filters.

Next, at step 510, one or more features from the preprocessed sound, vibration, and temperature data may be extracted. The one or more features may be associated with sinusoidal modulation features, time domain features, frequency domain features, time-frequency domain features, rhythm and temporal features, statistical features, Mel-Frequency Cepstral Coefficients (MFCCs), harmonic and timbral features, and waveform shape features. The sinusoidal modulation feature may allow for precise audio signal generation and modification. Further, the sinusoidal modulation feature may include changing the frequency, amplitude, or phase of sinusoidal audio signal components. Furthermore, sinusoidal modulation techniques such as Amplitude modulation (AM), frequency modulation (FM), and phase modulation (PM), may produce synthetic sound data that closely resembles audio characteristics associated with faults in the real world.

Next, at step 512, based on the extracted one or more features, anomaly in the mechanical components may be identified by employing one or more Machine Learning (ML) models. The one or more ML models may include Deep Neural Networks (DNN), Convolutional Neural Networks (CNNs), Support Vector Machines (SVMs), and Recurrent Neural Networks (RNNs). Further, the anomaly identification module is configured to identify a solution for the identified anomaly by employing the one or more ML models.

Thereafter, the identified anomaly in the mechanical components may be rendered to the user, at step 514. A solution to the identified anomaly may also be rendered to the user. The identified anomaly and the solution to the identified anomaly may be in a user-friendly format, facilitating easy interpretation and decision-making by operators or maintenance personnel. Further, the rendering may include visualizations of the sound, vibration, and temperature data collected from the machinery or mechanical components. The visualizations could include spectrograms, waveforms, or time-frequency plots, providing users with detailed insights into the detected anomalies and their characteristics. Moreover, the rendering may render real-time alerts or notifications to inform users about potential faults or abnormal conditions detected in the machinery. The method ends at step 716.

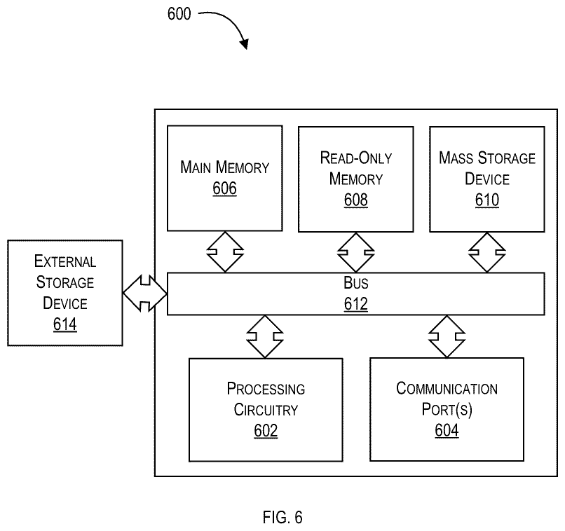

FIG. 6 illustrates an exemplary computer system in which or with which embodiments of the present disclosure may be utilized. As shown in FIG. 6, a computer system 600 includes an external storage device 614, a bus 612, a main memory 606, a read-only memory 608, a mass storage device 610, a communication port 604, and a processor 602.

Those skilled in the art will appreciate that computer system 600 may include more than one processor 602 and communication ports 604. Examples of processor 602 include, but are not limited to, an Intel® Itanium® or Itanium 2 processor(s), or AMD® Opteron® or Athlon MP® processor(s), Motorola® lines of processors, FortiSOC™ system on chip processors or other future processors. The processor 602 may include various modules associated with embodiments of the present disclosure.

The communication port 604 can be any of an RS-232 port for use with a modem-based dialup connection, a 10/100 Ethernet port, a Gigabit or 10 Gigabit port using copper or fiber, a serial port, a parallel port, or other existing or future ports. The communication port 604 may be chosen depending on a network, such as a Local Area Network (LAN), Wide Area Network (WAN), or any network to which the computer system connects.

The memory 606 can be Random Access Memory (RAM), or any other dynamic storage device commonly known in the art. Read-Only Memory 608 can be any static storage device(s) e.g., but not limited to, a Programmable Read-Only Memory (PROM) chips for storing static information e.g., start-up or BIOS instructions for processor 602.

The mass storage 610 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

The bus 612 communicatively couples processor(s) 602 with the other memory, storage, and communication blocks. The bus 612 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 602 to a software system.

Optionally, operator and administrative interfaces, e.g., a display, keyboard, and a cursor control device, may also be coupled to bus 604 to support direct operator interaction with the computer system. Other operator and administrative interfaces can be provided through network connections connected through communication port 604. An external storage device 610 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

The disclosed system and method (together termed as ‘disclosed mechanism’) for a anomaly analysis for detecting anomalies in mechanical components overcomes the drawbacks of the present technologies and offers several other advantages in enhancing machinery maintenance, optimizing operational efficiency, and reducing downtime. By analyzing the noise, vibration, and temperature data and correlating it with machinery anomalies, the mechanism can proactively identify potentially dangerous content malfunctions or irregularities in mechanical components before they escalate into critical failures or safety hazards. Further, by analyzing the noise, vibration, and temperature data and aligning it with machinery anomalies, the mechanism facilitates early detection of potential equipment malfunctions or safety hazards. For example, irregularities in vibration patterns or abnormal sound frequencies may signify underlying issues such as misalignment, bearing wear, or structural weaknesses in mechanical components. Furthermore, temperature variations may indicate thermal stress, overheating, or irregularities in mechanical components, providing valuable insights into their operational health. For example, a sudden increase in temperature beyond normal operating ranges may indicate a malfunction or impending failure in a particular component, prompting timely intervention to prevent catastrophic damage. Proactive analysis may enable prompt intervention to address emerging faults before they escalate into critical failures, thus bolstering operational safety and reliability. Overall, the mechanism's adeptness in interpreting noise and vibration signals and linking them to machinery anomalies ensures timely maintenance actions, enhancing overall equipment performance and longevity.

Unlike received data approaches, which may be limited in their ability to accurately detect faults or require extensive manual intervention, the disclosed mechanism leverages advanced techniques to achieve more reliable anomaly detection. One key advantage of the disclosed mechanism is its ability to enhance machinery maintenance practices. By continuously monitoring noise, vibration, and temperature patterns, the system can identify potential faults at an early stage, allowing maintenance teams to intervene proactively before issues escalate into costly failures. The proactive approach not only minimizes downtime but also extends the lifespan of machinery, resulting in significant cost savings for businesses. Additionally, the disclosed mechanism contributes to optimizing operational efficiency by providing real-time insights into machinery health. By promptly alerting operators to any abnormalities or deviations from normal operating conditions, the system enables timely adjustments to prevent production disruptions and ensure smooth operations. Furthermore, the ability to accurately diagnose faults improves decision-making regarding maintenance schedules and resource allocation, leading to improved overall efficiency. Overall, the disclosed mechanism represents a paradigm shift in machinery maintenance and performance optimization. Combining advanced noise, vibration, and temperature analysis techniques with real-time monitoring capabilities empowers businesses to maintain their equipment more effectively, minimize downtime, and maximize operational efficiency.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

While the foregoing describes various embodiments of the disclosure, other and further embodiments of the disclosure may be devised without departing from the basic scope thereof. The disclosure is not limited to the described embodiments, versions, or examples, which are included to enable a person having ordinary skill in the art to make and use the disclosure when combined with information and knowledge available to the person having ordinary skill in the art.

I/We claim:

1. A system to detect anomaly in mechanical components based on sound, vibration, and temperature analysis, the system comprising:
a receiver module to receive sound data, vibration data, and temperature data from the mechanical components in real-time in various operational conditions;
a synthesizer to generate synthesized sound data from the received sound data based on varying noise environment by performing at least one of: pitch changing, temporal stretching, and noise injection;
a pre-processor to preprocess the received data and the synthesized sound data, to remove background noise and thermal shifting;
a feature extraction module to extract one or more features from the preprocessed received data and the preprocessed synthesized data;
an anomaly identification module to identify anomaly in the mechanical components based on the extracted one or more features by employing one or more Machine Learning (ML) models; and
a rendering module to render at least the identified anomaly in the mechanical components to a user.

2. The system of claim 1, wherein the synthesizer is further configured to convert the vibration to an audio signal and corresponding sound data, such that the received sound data and the sound data corresponding to the vibration data are analyzed together.

3. The system of claim 1, wherein the synthesizer further enhances dataset by applying one or more data augmentation techniques on both received data and synthetic data.

4. The system of claim 1, wherein the preprocessing is performed at least one of: normalization, filtering, equalization, and noise reduction.

5. The system of claim 1, wherein the preprocessing further includes utilizing Non-Local Means (NLM) filtering to reduce noise, such that target signal is determined by locating and processing related audio patches.

6. The system of claim 1, wherein the preprocessing further includes reducing noise signals by statistical models including at least one of: Hidden Markov Models (HMMs) and Gaussian Mixture Models (GMMs).

7. The system of claim 1, wherein the preprocessing further includes changing audio spectrum information for balancing desired audio signal and undesirable background sound by utilizing at least one of: high-pass, low-pass, band-pass, and notch filters.

8. The system of claim 1, wherein the one or more features are associated with at least one of: sinusoidal modulation features, time domain features, frequency domain features, time-frequency domain features, rhythm and temporal features, statistical features, Mel-Frequency Cepstal Coefficients (MFCCs), harmonic and timbral features, and waveform shape features.

9. The system of claim 1, wherein the one or more ML models include at least one of: Deep Neural Networks (DNN), Convolutional Neural Networks (CNNs), Support Vector Machines (SVMs), and Recurrent Neural Networks (RNNs).

10. The system of claim 1, wherein the anomaly identification module is further configured to identify a solution for the identified anomaly by employing the one or more ML models, such that the rendering module also renders the identified solution to the user.

11. A method to detect anomaly in mechanical components based on sound and vibration analysis, the system comprising:
receiving sound data, vibration data, and temperature data from the mechanical components in real-time in various operational conditions;
generating synthesized sound data from the received sound data based on varying noise environment by performing at least one of: pitch changing, temporal stretching, and noise injection;
preprocessing the received data and the synthesized sound data to remove background noise and thermal shifting;
extracting one or more features from the preprocessed received data and the preprocessed synthesized data;
identifying anomaly in the mechanical components based on the extracted one or more features by employing one or more Machine Learning (ML) models; and
rendering at least the identified anomaly in the mechanical components to a user.

12. The method of claim 11, wherein the synthesizer is further configured to convert the vibration data to an audio signal and corresponding sound data, such that the received sound data and the sound data corresponding to the vibration are analyzed together.

13. The method of claim 11, wherein the synthesizer further enhances dataset by applying one or more data augmentation techniques on both received data and synthetic data.

14. The method of claim 11, wherein the preprocessing is performed at least one of: normalization, filtering, equalization, and noise reduction.

15. The method of claim 11, wherein the preprocessing further includes utilizing Non-Local Means (NLM) filtering to reduce noise, such that target signal is determined by locating and processing related audio patches.

16. The method of claim 11, wherein the preprocessing further includes reducing noise signals by statistical models including at least one of: Hidden Markov Models (HMMs) and Gaussian Mixture Models (GMMs).

17. The method of claim 11, wherein the preprocessing further includes changing audio spectrum information for balancing desired audio signal and undesirable background sound by utilizing at least one of: high-pass, low-pass, band-pass, and notch filters.

18. The method of claim 11, wherein the one or more features are associated with at least one of: sinusoidal modulation features, time domain features, frequency domain features, time-frequency domain features, rhythm and temporal features, statistical features, Mel-Frequency Cepstal Coefficients (MFCCs), harmonic and timbral features, and waveform shape features.

19. The method of claim 11, wherein the one or more ML models include at least one of: Deep Neural Networks (DNN), Convolutional Neural Networks (CNNs), Support Vector Machines (SVMs), and Recurrent Neural Networks (RNNs).

20. The method of claim 11, wherein the anomaly identification module is further configured to identify a solution for the identified anomaly by employing the one or more ML models, such that the rendering module also renders the identified solution to the user.
